(19) United States
(12) Patent Application Publication
(10) Pub. No.: US 2005/0026625 A1
(43) Pub. Date: Feb. 3, 2005

(54) Methods and devices for seamlessly changing protocols in a mobile unit

(76) Inventors: Narayan L. Gehlot, Sayreville, NJ (US); Victor B. Lawrence, Holmdel, NJ (US)

Correspondence Address: HARNESS, DICKEY & PIERCE, P.L.C., P.O. Box 8910, Reston, VA, 20195, US

(21) Appl. No.: 10/628,206

(22) Filed: Jul. 29, 2003

(51) Int. Cl. H04B 7/00

(52) U.S. Cl. 455/456.1; 455/12.1

(57) ABSTRACT

“Look-ahead” techniques for operating a mobile unit include estimating its future location and selecting a protocol based on a future location coordinate. Thus, the mobile unit can prepare to change from a present protocol to another, selected protocol before the mobile unit is handed-off to a base station whose network operates according to the selected protocol.

### CROSS-REFERENCE TO RELATED APPLICATION

This application is related to U.S. patent application Ser. No. 10/079,755 filed on Feb. 19, 2002, by the same assignee, the contents of which are hereby incorporated by reference in its entirety, and to U.S. patent application Ser. No. ______, entitled METHODS AND SYSTEMS FOR CONTROLLING HANDOFFS IN A WIRELESS COMMUNICATION SYSTEM filed concurrently herewith by the assignee, and having the same inventors, the contents of which are hereby incorporated by reference in its entirety.

### BACKGROUND OF THE INVENTION

1. Field of the Invention

The present invention relates to wireless communications utilizing a mobile unit and, particularly, to a technique for seamlessly switching protocols in a mobile unit.

2. Description of the Related Art

Today, many mobile wireless devices, such as wirelessly enabled laptop or palmtop computers, wirelessly enabled personal digital assistants (PDA's), mobile telephones, etc., are capable of operating using more than one type of wireless network. Such devices will herein be referred to as “mobile units.” A mobile unit may, for example, transmit data to, and receive data from, a remote server or host via a wireless local area network (e.g., Wavelan) when the mobile unit is indoors. When the mobile unit is later moved outdoors, it may then communicate via a cellular (e.g., GSM) network. In this example, when the mobile unit is moved outdoors, it may be handed off from a “serving” base station belonging to the Wavelan network to another base station belonging to the GSM network.

When a mobile unit transitions between different types of networks, the mobile unit must operate according to different protocol signals (e.g., network and link level protocol signals). Changing protocols causes certain communication properties to change as well. If an application (e.g., internet software or firmware application) in the mobile unit is conducting a “data session” with a remote host when the change occurs, and the application is not prepared for the change, the data session may be dropped.

Conventional base stations rely on fixed cell divisions of different sizes (e.g., macro- and micro-cells), as described in U.S. Patent No. 6,212,405 to Jiang, to perform “protocol rollovers.”

A conventional mobile unit determines which base station to use based on measurements of received signal strength from different base stations and then uses a protocol appropriate for that base station. This is a “look-back” technique since it requires the mobile unit to base its determination as which protocol to use by looking back at already-received signal strength measurements. However, multipath effects may cause the received signal strengths of the base stations to change rapidly. This may cause the mobile unit to make frequent and unnecessary changes in protocol, resulting in high rates in dropped connections and dropped calls.

### SUMMARY OF THE INVENTION

The problems with look back techniques may be avoided, in accordance with the principles of the invention, by determining a future location of the mobile unit, and selecting a prescribed protocol based on the determined future location. Advantageously, the mobile unit can anticipate and prepare for handoffs between base stations corresponding to different types of networks, based, at least in part, on the mobile unit's present and future location. Such a technique can be referred to as a “look ahead” technique.

In accordance with an aspect of the invention, a path of motion for the mobile unit is determined, and the future location coordinate is based on the path of motion.

The protocol selected may be determined using a “lookup” in a database based on the future location coordinate to select a protocol.

Advantageously, by knowing where it is going to be, the mobile unit can properly prepare for a handoff between base stations of different types of networks, where each network requires the mobile unit to operate according to a different protocol before performing the handoff is actually required. Such preparation can allow the mobile unit to switch its operations from one protocol to another seamlessly, i.e., without causing a data session to be dropped.

### BRIEF DESCRIPTION OF THE DRAWINGS

FIGS. 1A and 1B are simplified schematic diagrams illustrating elements for implementing techniques for seamlessly changing protocols according to an exemplary embodiment of the present invention.

FIG. 2 is a simplified schematic diagram illustrating components of a mobile unit according to an exemplary embodiment of the present invention.

FIG. 3 is a simplified flowchart illustrating a technique for operating a mobile unit to seamlessly change between different protocols during a handoff according to an exemplary embodiment of the present invention.

### DETAILED DESCRIPTION OF EXEMPLARY EMBODIMENTS

In accordance with principles of the invention, a mobile unit can anticipate and prepare for handoffs by, for example, determining a future location of the mobile unit and selecting a corresponding protocol.

In accordance with an aspect of the invention, a mobile unit conducts a data session by communicating with a remote host or server using one or more different communication networks, each type of network requiring the mobile unit to operate according to a different protocol. The mobile unit may be equipped with Global Positioning System (GPS) receivers to receive and record location and time coordinates obtained from a GPS satellite.

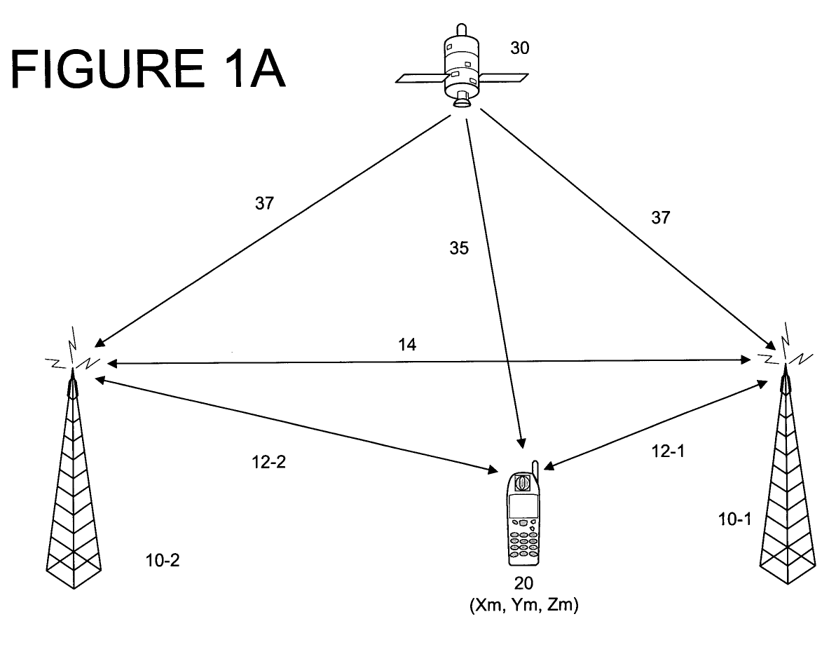

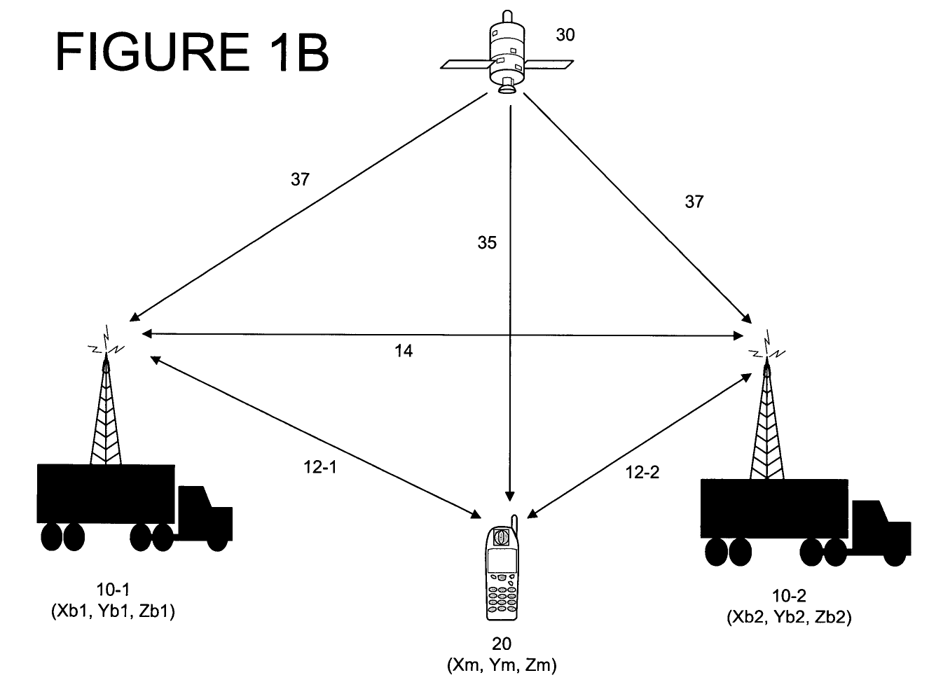

For example, FIG. 1A illustrates a mobile unit 20, which receives and extracts GPS data, including location and time coordinates, from data transmissions received via pathway 35. FIG. 1A also illustrates a serving base station 10-1 belonging to one type of communication network (for example, a Wavelan), and another non-serving base station 10-2 belonging to another type of network (e.g., GSM).

While FIG. 1A illustrates only one non-serving base station 10-2, there may be a plurality of non-serving base stations (which will be collectively referred to herein as “10-2”) to which the mobile unit 20 may be handed off. These non-serving base stations 10-2 may correspond to a plurality of different types of networks, including but not limited to, cellular networks, Wavelan (including both IEEE 802.11 based networks and Bluetooth systems), existing and currently evolving third generation (3G) networks, and Bluetooth personal area networks (PANs).

The base stations 10-1, 10-2 of the wireless communication system may be stationary and fixed at their respective locations. Accordingly, the mobile unit 20 can identify each base station 10-1 and 10-2 according to the location coordinates extracted from the time-space vector transmitted by the corresponding base station. As shown in FIG. 1A, base stations 10-1 and 10-2 may respectively receive GPS signals via pathways 37 from the GPS satellite 30.

Alternatively, the wireless system may include base stations 10-1, 10-2 that are not stationary. In military applications, for instance, wireless communications can be facilitated in the field through the use of base station towers (antennas) carried on the back of trucks. FIG. 1B is a schematic diagram, which differs from FIG. 1A in that it illustrates non-stationary base stations 10-1 and 10-2.

In U.S. patent application Ser. No. ______, entitled “Methods and Systems for Controlling Handoffs in a Wireless Communication System Using Time-Space Vectors,” which is filed concurrently herewith and whose contents are incorporated herein by reference in its entirety, there are disclosed techniques by which a mobile station 20 can be handed off between a serving base station 10-1 and a chosen non-serving base station 10-2 based on time-space vectors transmitted between the mobile unit 20 and the base stations 10-1 and 10-2. A description of these time-space vectors is given below.

Referring to FIG. 1A, the mobile unit 20 may transmit a time-space vector, which includes time and location information obtained from the GPS signal transmitted via pathway 35, to a serving base station 10-1 corresponding to a first type of network and another non-serving base station 10-2 using data transmission pathways 12-1 and 12-2, respectively.

Furthermore, each of the base stations 10-1 and 10-2 may be capable of receiving GPS signals via pathways 37, and transmitting a time-space vector to the mobile unit 20 via pathways 12-1 and 12-2, respectively.

As used herein, the term “time-space vector” refers to a set of location and time coordinates, and should not be construed as requiring a particular data format for combining these coordinates.

For example, the location coordinates of a time-space vector may use a three dimensional (3D) coordinate system to represent a longitudinal position, a latitudinal position, and a relative height above sea level. In an exemplary embodiment, the coordinate system may be Cartesian, i.e., rectangular (x, y, z). However, it should be noted that the time-space vector may use other known coordinate systems, e.g., cylindrical, spherical, and two-dimensional (2D) systems. See for example, “Introduction to Modern Electromagnetics” by Carl H. Durney and Curtis C. Johnson (hereinafter “Durney and Johnson”), pp. 10-11, section 1.4, published by McGraw-Hill, Library of Congress Catalog Number 69-13605.

The vectors may be processed using a number of different techniques to generate various values associated with, or representative of, the vectors. See for example Durney and Johnson, pp. 39-65 (magnitude, vector gradient, divergence, curl, derivatives or integrals).

The location coordinates in a time-space vector may represent a location within an area grid having a pre-defined granularity. For example, a Cartesian (x, y, z) grid may be assigned to define regions within a particular area (e.g., city or state), such that the grid coordinates are separated by a pre-defined distance (e.g., 5 meters).

The time information of the time-space vector may include a time coordinate representing the time at which the corresponding GPS signal was received. For example, the time coordinate may be generated by a Cesium clock aboard the GPS satellite 30.

The time-space vectors may be transmitted between the mobile station 20 and the base stations 10-1 and 10-2 by utilizing preamble bits, or any free bits, in data packets being transmitted between these devices via pathways 12-1 and 12-2. The time-space vector may alternatively be transmitted using a separate pilot tone, or using a separate channel superimposed on the basic signal channel of pathways 12-1 and 12-2

For the purposes of illustration in connection with the following disclosure, a time-space vector will be represented as including location coordinates x, y, and z, and a time coordinate t. For example, in FIGS. 1A and 1B, the mobile unit 20 is shown as being located at a position (Xₘ, Yₘ, Zₘ). Thus, the time-space vector transmitted by the mobile unit would be represented as (Xₘ, Yₘ, Zₘ, Tₘ), where Tₘ represents the time of transmission.

The serving base station 10-1 may use the time-space vectors received from the mobile unit 20 via pathway 12-1 to determine whether a handoff is appropriate. For example, using the location coordinates (Xₘ, Yₘ, Zₘ), the serving base station 10-1 may use a database that maps the coverage area of each of the set of base stations 10-1 and 10-2 within a particular area.

Accordingly, the database may divide a particular area into different regions, and designate a base station 10-1, 10-2 that provides the best service for that region (i.e., designate that region as the coverage area for a particular base station 10-1, 10-2). For example, the coverage area of each base station 10-1, 10-2 may include the region in which the base station 10-1, 10-2 provides the highest signal strength and/or the best service quality (e.g., the lowest call drop rate). The region corresponding to each base station's 10-1, 10-2 coverage area may also be determined based on the presence of geographical obstacles and or environmental conditions that may affect service quality for the base station 10-1, 10-2, e.g., by causing multipath reflections or the like.

The database may further associate each region with a particular protocol (or protocols) supported by the base station 10-1, 10-2 to which the region is mapped. Thus, the database may be referred to as a “protocol database.” For example, if the serving base station 10-1 belongs to a Wavelan network, the protocol database will associate the region corresponding to serving base station's 10-1 coverage area with a Wavelan protocol. The coverage area of a non-serving base station, which is connected to a GSM network, will be associated with the GSM protocol in the database.

The protocol database or portions thereof can be maintained and updated using any server(s) or data processing system(s) located at a base station 10-1 or 10-2, a mobile switching center (MSC), an application server, or any other component(s) and subsystem(s) of one or more of the networks whose base stations 10-1 and 10-2 are covered in the database. The protocol database may also be maintained as a plurality of databases (collectively referred to herein as the “protocol database”), which are maintained at different entities or different locations. Alternatively, the protocol database may be maintained in a standalone entity, or stored in the mobile unit 20 itself, e.g., in an application specific integrated circuit (ASIC) or the like.

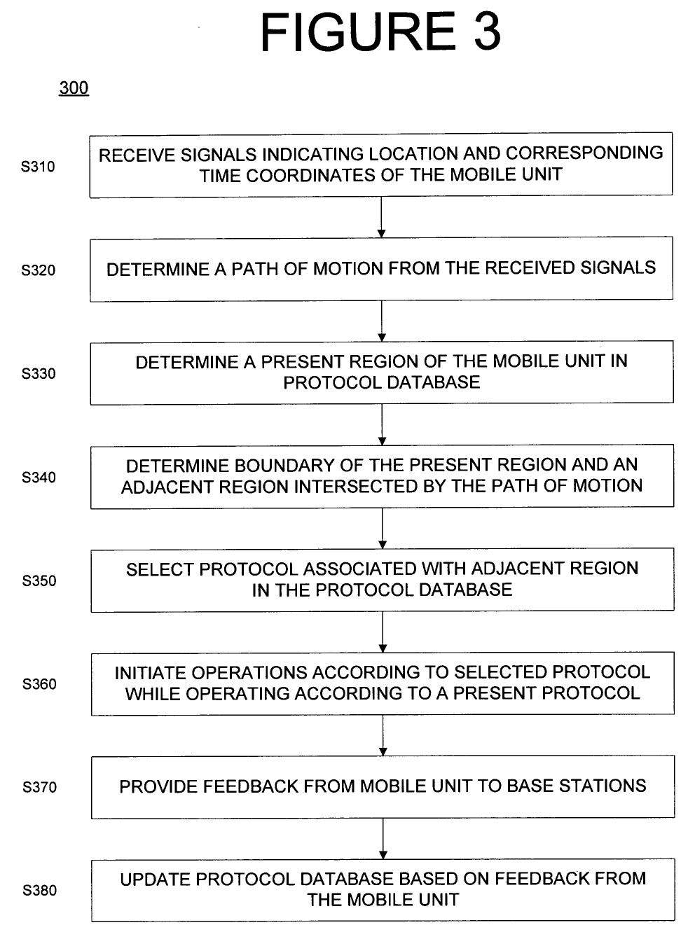

FIG. 3 is a flowchart illustrating a technique for operating the mobile unit 20 to seamlessly switch between different protocols during a handoff. The mobile unit 20 may initially be operating according to a protocol chosen at power-up by performing a lookup in a database (this step not shown). Alternatively, the initial selection of a protocol may be pre-programmed, or made by another known technique.

In step S310, the mobile unit 20 receives GPS signals including a location and corresponding time coordinate, which represent the location and the time at which the GPS signals are received by the mobile unit 20.

In step S320, the mobile unit 20 may use one or more sets of corresponding GPS location and time coordinates to determine a path of motion along which it is traveling.

The mobile unit 20 may receive a plurality of GPS signals representing a plurality of locations visited by the mobile unit 20, along with the corresponding times at which the mobile unit 20 arrived at each location. Using techniques known within the art, a direction of movement and velocity can be calculated for the mobile unit 20. The calculated location and velocity, along with the current location of the mobile unit 20 (as determined from GPS signals) are collectively referred to as the mobile unit's 20 path of motion.

Alternatively, historical data can be used to determine the mobile unit's 20 path of motion. Such an embodiment is useful where a user regularly takes his mobile unit 20 along the same path of motion at roughly the same time on a daily, regular, or periodic basis. For example, the user may take the mobile unit 20 along the same route when she goes to work each day, and when she returns home. Therefore, the mobile unit 20 will receive a set of GPS signals, whose location and time coordinates are roughly the same, each time she takes one of these trips.

Such historical data can be stored, for example, in a historical database. Thus, based on the current location of the mobile unit 20 and the current time, the mobile unit 20 may be able to determine an expected path of motion, i.e., the direction and velocity at which the mobile unit 20 is expected to travel. Alternatively, the mobile unit 20 may only need the current time to determine its expected path of motion (e.g., the path it normally travels at this time each day) from the historical database. Such a historical database may be maintained, for example, by the same component or entity that maintains the protocol database. Alternatively, such historical data may actually be programmed into the mobile unit, e.g., by the mobile user using known techniques.

Continuing in step S330, the mobile unit 20 determines its current location based on the received GPS signals. The mobile unit's 20 current location may be used to determine a present region in the protocol database where the mobile unit 20 is currently situated. The mobile unit 20 may send a time-space vector to the base station 10-1, 10-2, or other component, which stores and maintains the protocol database.

The present region generally corresponds to the coverage area of the base station 10-1 currently serving the mobile unit 20. However, this may not always be the case; for example, the base station 10-1 may decide to handoff the mobile unit 20 because of service quality, traffic load, environmental conditions, or other conditions that arose after the protocol database was last updated.

In step 350, the protocol database is used to determine a future location coordinate for the mobile unit 20 based on the mobile unit's 20 current location and its determined path of motion. The future location coordinate can represent a location to which the mobile unit 20 is heading, where the mobile unit 20 is likely to be handed off. In particular, the future location coordinate can represent a boundary between the present region (corresponding to the serving base station's 10-1 coverage area) and an adjacent region (corresponding to another base station's 10-2 coverage area).

For example, if the path of motion indicates that the mobile unit 20 is moving in an eastward direction, step 350 determines the boundary of a region mapped in the protocol database, which is adjacent to the present region and due east of the mobile unit's 20 current location. Using the velocity component of the path of motion, a determination can be made of a future time at which the mobile unit 20 is likely to reach the future location.

According to step S350, an appropriate protocol is then selected for the mobile unit 20. This protocol is associated with the adjacent region corresponding to the determined boundary, i.e., the determined future location coordinate at which the mobile unit 20 is expected to be handed-off.

This step allows the mobile unit 20 to be notified of the selected protocol, and to prepare for the anticipated handoff. If the adjacent region corresponds to a non-serving base station 10-2 that is part of the same wireless network as the serving base station 10-1, then the selected protocol will be the same as the “present” protocol under which the mobile unit 20 is currently operating. Thus, the handoff should not affect any data sessions being conducted by the mobile unit 20.

However, if the selected protocol is different than the present protocol of the mobile unit 20, the mobile unit 20 can prepare for the change that will occur when the handoff is performed. Step S360 illustrates such preparatory activities.

The mobile unit 20 may initiate operations according to the selected protocol (if different than the present protocol), while the mobile unit 20 is still operating according to the present protocol. Specifically, a processor in the mobile unit 20 may have both protocols running simultaneously. This step S360 may be performed immediately after the mobile unit 20 is notified of the selected protocol, or at a time when it is determined that a handoff to a base station 10-2, whose network corresponds to the selected protocol, occurs.

At an appropriate time, or when the mobile unit 20 reaches an appropriate location, the mobile unit 20 alters its operations to use the selected protocol to perform data communications. Thus, a smooth rollover between the present protocol and the selected protocol may be performed seamlessly. This prevents a user from becoming frustrated due to a dropped call or connection, or a discontinuation of services. This also helps reduce or prevent poor service quality and prevent application lock-ups.

Because the serving base station 10-1 may similarly rely on the protocol database to initiate handoffs (as described above), the notification to the mobile unit 20 of the selected protocol is a more reliable indication of an anticipated handoff than other known methods, e.g., signal strength measurements.

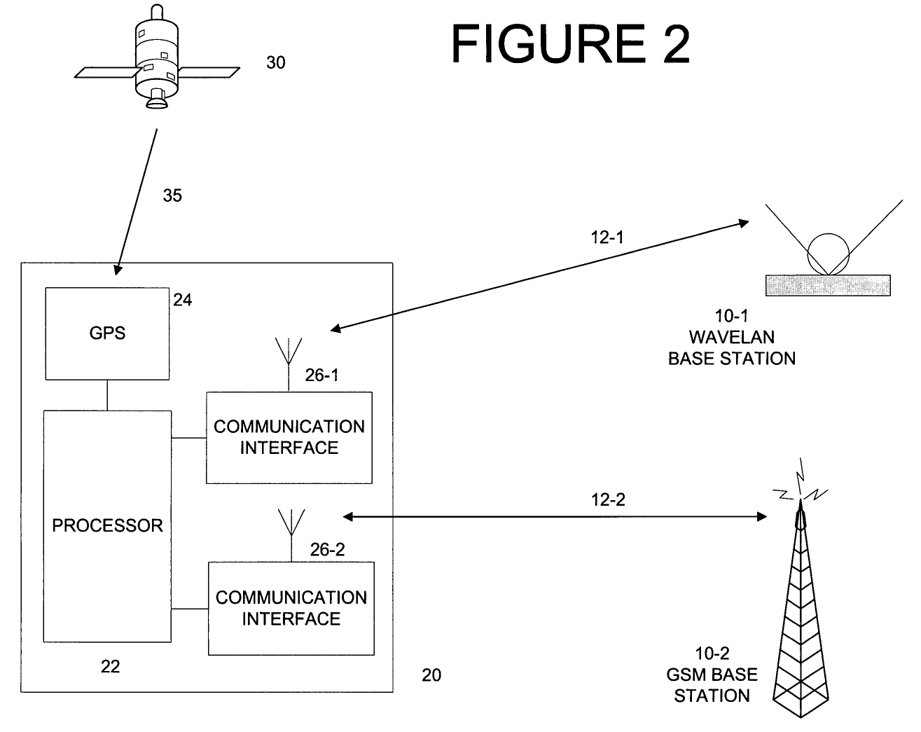

In order to describe step S360 more clearly, reference will be made to FIG. 2. FIG. 2 is a schematic diagram illustrating components of the mobile unit 20 according to an exemplary embodiment of the present invention. FIG. 2 is used for the purposes of illustrating a particular example where a handoff is performed between a Wavelan network and a GSM network. However, FIG. 2 in no way limits the present invention to such networks, or to any particular implementation.

As shown in FIG. 2, the mobile unit 20 includes a processor 22 that may execute applications. The processor is connected to a GPS interface 24, and two communication interfaces 26-1 and 26-2. Wavelan communication interface 26-1 is used for transmitting and receiving data according to the Wavelan protocol, i.e., the protocol associated with the serving base station 10-1 in FIG. 2. GSM communication interface 26-2 is used for transmitting and receiving data according to the protocol associated with the non-serving base station 10-2.

While the mobile unit 20 is served by the Wavelan base station 10-1, and an application executed in the processor 22 is conducting a data session with a remote host or server, the processor 22 routes data between the application and the Wavelan communication interface 26-1. This data is to be communicated between the remote host/server (not shown) and the application via the Wavelan network of the serving base station 10-1.

However, when mobile unit 20 approaches the boundary between the coverage areas of the Wavelan base station 10-1 and the non-serving base stations 10-2, the GSM protocol is selected, based on GPS signals received via GPS interface 24 (according to steps S310-S350 discussed above). The processor 22 may then initiate the GSM communication interface 26-2 to begin operating while the Wavelan communication interface 26-1 continues to operate. Thus, both protocols can be running at substantially the same time.

Thus, when mobile unit 20 is handed-off from base station 10-1 to base station 10-2, the processor 22 simply has to alter the operations of the application such that it routes data to, and processes data from, the GSM communication interface 26-2 (rather than the Wavelan communication interface 26-1). Because this involves little interruption in the data session conducted by the application, the data session can be maintained. Thus, the change between the present protocol (e.g., Wavelan) and the selected protocol (e.g., GSM) may be seamless.

As noted above, FIG. 2 is merely used for illustrative purposes only, and does not limit the configuration of the mobile unit 20, or the types or number of different networks with which the mobile unit 20 can be used.

Referring back to FIG. 3, step S370 shows that the mobile unit 20 may be configured to provide feedback to the serving base station 10-1 (both before and after a handoff occurs). For example, the mobile unit 20 may transmit measurements of received signal strength, current environmental conditions (e.g., weather) being detected, or other types of data relating to service quality at the mobile unit's current location. Such information may be received by the serving base station 10-1 and used to update the protocol database, e.g., to update the boundaries of the coverage areas of respective base stations 10-1 and 10-2, as indicated in step S380.

It should be noted that the invention, as described above, may be varied in many ways. Such variations are not to be regarded as a departure from the spirit and scope of the invention. All such modifications as would be readily apparent to those skilled in the art are intended to be included within the scope of the following claims.

1. A method for operating a mobile unit, comprising the steps of:
determining a future location coordinate of a mobile unit; and
selecting a protocol, for use by the mobile unit, based on the future location coordinate.

2. The method of claim 1, further comprising the steps of:
receiving signals representing a location and corresponding time coordinate of the mobile unit;
determining a path of motion of the mobile unit based on the received signals; and
determining the future location coordinate based on the path of motion.

3. The method of claim 2, further comprising the steps of:
receiving signals representing a plurality of location and corresponding time coordinates of the mobile unit; and
determining the path of motion by calculating a direction of the mobile unit based on the plurality of location and time coordinates.

4. The method of claim 2, further comprising the steps of:
storing previous location and time coordinates of the mobile unit in a historical database;
obtaining a coordinate representing at least one of a current time and a current location of the mobile unit; and
performing a lookup in the historical database based on the obtained coordinate to determine an expected path of motion for the mobile unit.

5. The method of claim 2, further comprising the steps of:
maintaining a protocol database associating a protocol with at least one region;
obtaining a coordinate representing a current location of the mobile unit;
determining a present region in the protocol database based on the current location of the mobile unit; and
determining the future location coordinate as a boundary of the present region in the protocol database that intersects the path of motion, wherein the boundary separates the present region from an adjacent region.

6. The method of claim 5, wherein the selecting step further comprises the step of:
selecting the protocol associated with the adjacent region in the protocol database.

7. The method of claim 6, further comprising the step of:
revising the protocol database based on service of quality data corresponding to the mobile unit.

8. The method of claim 6, further comprising the step of:
revising the protocol database based on detected changes in environmental conditions.

9. The method of claim 1, further comprising the step of:
initiating operations according to the selected protocol while substantially operating using a present protocol.

10. The method of claim 1, further comprising the steps of:
operating an application in the mobile unit to process data according to a present protocol; and
altering operations of the application to process data according to the selected protocol at a time substantially contemporaneous with the mobile unit's arrival at a location corresponding to the future location coordinate.

11. The method of claim 10, further comprising the step of:
operating the application to conduct a data session, wherein the data session is maintained while the operations of the application are altered.

12. The method of claim 9, wherein the present and selected protocols each correspond to a different communication network selected from the group consisting of at least: a wireless local area network (Wavelan) and a cellular network.

13. A mobile unit operable to:
determine a future location coordinate of the mobile unit; and
select a protocol, for use by the mobile unit, based on the future location.

14. The mobile unit of claim 13, further operable to:
receive signals representing a plurality of location and corresponding time coordinates;
determine a path of motion, wherein the path of motion includes a present location and a direction calculated based on the plurality of location and corresponding time coordinates; and
determine the future location coordinate based on the path of motion.

15. The mobile unit of claim 14, further operable to:
perform a lookup in a protocol database based on the path of motion, wherein the protocol database associates a protocol with each of at least one region;
determining a present region based on the performed lookup;
and selecting the protocol associated with the present region in the protocol database.

16. The mobile unit of claim 13, further operable to:
initiate operations according to the selected protocol while substantially operating using a present protocol.

17. The mobile unit of claim 13, further operable to:
operate an application to process data according to a present protocol; and
alter operations of the application to process data according to the selected protocol at a time substantially contemporaneous with an arrival at a location corresponding to the future location.

18. A base station operable to:
maintain a protocol database associating a protocol with each of at least one region;
obtain a path of motion for a mobile unit, wherein the path of motion includes a current location and a direction of the mobile unit;
determine a present region in the protocol database based on the current location of the mobile unit; and
determine a future location coordinate of the mobile unit as a boundary of the present region in the protocol database that intersects the path of motion, wherein the boundary separates the present region from an adjacent region.

19. The base station of claim 18, further operable to:
receive signals representing the path of motion of the mobile unit.

20. The base station of claim 18, further operable to:
receive signals representing a plurality of location and corresponding time coordinates of the mobile unit;
store the received location and corresponding time coordinates in a historical database;
obtain a coordinate representing at least one of a current time and a current location of the mobile unit; and
perform a lookup of the historical database based on the obtained coordinate to determine an expected path of motion for the mobile unit.

21. The base station of claim 18, further operable to:
receive signals from a mobile unit representing service quality data relating to the mobile unit's current location; and
update the protocol database based on the service quality data.

22. The base station of claim 21, further operable to:
update boundaries of the at least one region in the protocol database based on the service quality data.

23. A mobile unit comprising:
means for determining a future location coordinate of the mobile unit; and
means for selecting a protocol, for use by the mobile unit, based on the future location.

24. A base station comprising:
means for maintaining a protocol database associating a protocol with each of at least one region;
means for obtaining a path of motion for a mobile unit, wherein the path of motion includes a current location and a direction of the mobile unit;
means for determining a present region in the protocol database based on the current location of the mobile unit; and
means for determining a future location coordinate of the mobile unit as a boundary of the present region in the protocol database that intersects the path of motion, wherein the boundary separates the present region from an adjacent region.
